(19) United States
(12) Patent Application Publication
(10) Pub. No.: US 2026/0150047 A1
(43) Pub. Date: May 28, 2026

(54) SIGNAL RECEIVING METHOD, SIGNAL SENDING METHOD, SIGNAL RECEIVING APPARATUS, AND SIGNAL SENDING APPARATUS

(71) Applicant: Beijing Xiaomi Mobile Software Co., Ltd., Beijing (CN)

(72) Inventors: Shengxiang GUO, Beijing (CN); Lai WANG, Beijing (CN)

(21) Appl. No.: 19/120,010

(22) PCT Filed: Oct. 12, 2022
(86) PCT No.: PCT/CN2022/124800

§ 371 Date: Apr. 10, 2025

(51) Int. Cl. H04W 52/02; H04L 27/26; H04W 72/0453

(52) U.S. Cl. CPC H04W 52/0235; H04L 27/26025; H04W 72/0453

(57) ABSTRACT

A signal receiving method is performed by a terminal, and includes: receiving a power saving signal transmitted by an access network device through at least one frequency domain unit, wherein the power saving signal indicates whether to wake up a main receiver or a main transceiver of the terminal, the main receiver is used to process downlink data, and the main transceiver is used to process at least one of uplink data or the downlink data.

### CROSS-REFERENCE TO RELATED APPLICATION

This application is the U.S. national phase application of International Application No. PCT/CN2022/124800, filed on Oct. 12, 2022, the disclosure of which is incorporated herein by reference in its entirety.

### TECHNICAL FIELD

The present disclosure relates to the field of mobile communications, and in particular to a signal receiving method and apparatus and a signal transmitting method and apparatus.

### BACKGROUND

In a mobile communication system, a power saving signal may be introduced to trigger a terminal as to whether it is to start processing uplink data and downlink data in a normal way. An access network device may trigger the terminal to process the uplink data and the downlink data by transmitting the power saving signal to the terminal. If the access network device does not trigger the terminal to process the uplink data and the downlink data through the power saving signal, the terminal is in a sleep state to save the terminal overhead. However, how to transmit the power saving signal between the terminal and the access network device has become an urgent problem to be solved.

### SUMMARY

Examples of the present disclosure provide a signal receiving method and apparatus and a signal transmitting method and apparatus, which ensure that a terminal adjusts its own working state in accordance with a power saving signal, thereby improving the accuracy and reliability of terminal communications. The technical solutions are as follows.

According to one aspect of the present disclosure, a signal receiving method is provided. The method is performed by a terminal and includes: receiving a power saving signal transmitted by an access network device through at least one frequency domain unit, wherein the power saving signal indicates whether to wake up a main receiver or a main transceiver of the terminal, the main receiver is used to process downlink data, and the main transceiver is used to process uplink data and/or the downlink data.

According to another aspect of the present disclosure, a signal transmitting method is provided. The method is performed by an access network device and includes: transmitting a power saving signal to a terminal through at least one frequency domain unit, wherein the power saving signal indicates whether to wake up a main receiver or a main transceiver of the terminal, the main receiver is used to process downlink data, and the main transceiver is used to process uplink data and/or the downlink data.

According to another aspect of the present disclosure, a terminal is provided, which includes: one or more processors; one or more transceivers connected to the one or more processors; and one or more memories for storing executable instructions of the one or more processors. The one or more processors are configured to receive a power saving signal transmitted by an access network device through at least one frequency domain unit, wherein the power saving signal indicates whether to wake up a main receiver or a main transceiver of the terminal, the main receiver is used to process downlink data, and the main transceiver is used to process uplink data and/or the downlink data.

### BRIEF DESCRIPTION OF THE DRAWINGS

The drawings to be used in the description of the examples of the present disclosure are briefly introduced. It is clear that, the drawings in the following description illustrate only some examples of the present disclosure.

FIG. 1 illustrates a block diagram of a communication system provided in an example of the present disclosure.

FIG. 2 illustrates a flowchart of a signal transmission method provided in an example of the present disclosure.

FIG. 3 illustrates a block diagram of a signal receiving apparatus provided in an example of the present disclosure.

FIG. 4 illustrates a block diagram of another signal receiving apparatus provided in an example of the present disclosure.

FIG. 5 illustrates a block diagram of a signal transmitting apparatus provided in an example of the present disclosure.

FIG. 6 illustrates a block diagram of another signal transmitting apparatus provided in an example of the present disclosure.

FIG. 7 illustrates a schematic structural diagram of a communication device provided in an example of the present disclosure.

### DETAILED DESCRIPTION OF THE EMBODIMENTS

Examples will be described in detail herein, illustrations of which are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “the” and “said” in their singular forms used in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the present disclosure to describe various information, such information should not be limited to these terms. These terms are only used to distinguish the information of the same type with each other. For example, without departing from the scope of the present disclosure, first information may be referred to as second information; and similarly, second information may also be referred to as first information. Depending on the context, the word “if” as used herein may be interpreted as “when,” “upon,” or “in response to determining.”

It is to be noted that all information (including but not limited to user equipment information, user personal information, etc.), all data (including but not limited to data used for analysis, storage, display, etc.) and all signals involved in the present disclosure are authorized by users or fully authorized by various parties, and it should comply with the relevant laws, regulations and standards of relevant countries and regions to collect, use and process the relevant data.

The terms involved in the present disclosure are first described.

Power saving signal: A main receiver or a main transceiver of a terminal may be in a sleep state in a case where no data processing is required, and an access network device may wake up the main receiver or the main transceiver through the power saving signal, so that the terminal can save resources in the case where no data processing is required.

Main receiver: If it is expected to receive downlink data transmitted by the access network device, the terminal may receive the downlink data by the main receiver and may also process the downlink data by the main receiver. It is to be noted that the terminal further includes a corresponding auxiliary receiver which may receive the power saving signal transmitted by the access network device.

Main transceiver: If it is expected to receive the downlink data transmitted by the access network device or transmit uplink data to the access network device, the terminal may receive the downlink data transmitted by the access network device by the main transceiver or transmit the uplink data to the access network device by the main transceiver. It is to be noted that the terminal further includes a corresponding auxiliary transceiver which may receive the power saving signal transmitted by the access network device.

Next, a scenario where the present disclosure is applied is described below.

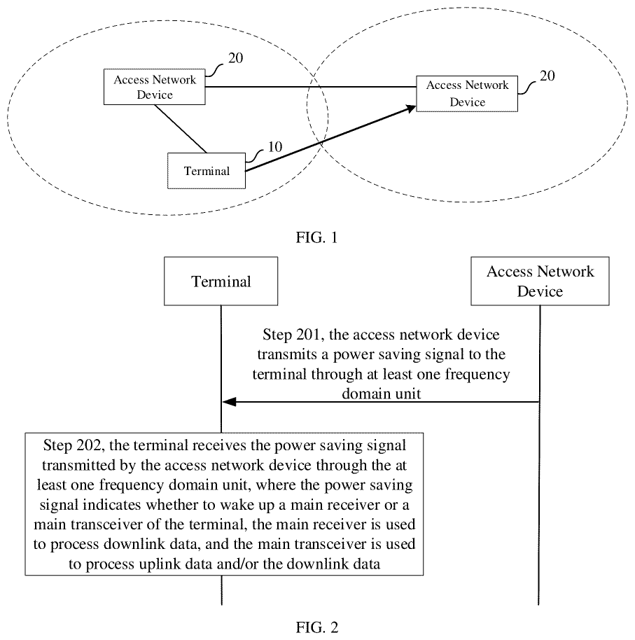

FIG. 1 illustrates a block diagram of a communication system provided in an example of the present disclosure. The communication system may include one or more terminals 10 and one or more access network devices 20.

There may typically be a plurality of terminals 10. There may be one or more than one terminal 10 distributed in a cell managed by each access network device 20. The terminal 10 may include a device in various types with a wireless communication function, like a handhold device, a vehicle-mounted device, a wearable device, a computing device or another processing device connected to a wireless modem, as well as user equipment (UE), a mobile station (MS), etc. in various forms. For the convenience of description, the above-mentioned devices are collectively referred to as terminals in the examples of the present disclosure.

The access network device 20 is a device deployed in an access network to provide wireless communication functions for the one or more terminals 10. For ease of description, the devices for providing the wireless communication functions for the one or more terminals 10 are collectively referred to as access network devices. A connection may be established between the access network device 20 and the terminal 10 via a radio interface, so that communications are performed via the connection, including signaling interactions and data interactions. There may be a plurality of access network devices 20. Two adjacent access network devices 20 may communicate with each other by wired or wireless means. The terminal 10 may send beam reports to different access network devices 20, that is, establish connections with different access network devices 20.

The access network device 20 may include various forms, such as a macro base station, a micro base station, a relay station, and an access point. In systems adopting different wireless access technologies, the device equipped with the access network device functions may have different names. For example, it is called gNodeB or gNB in a 5th generation (5G) new radio (NR) system. As communication technologies evolve, the name “access network device” may change.

The “5G NR system” in the examples of the present disclosure may also be referred to as a 5G system or an NR system, and its meaning may be understood by those skilled in the art. The technical solutions described in the examples of the present disclosure may be applied to the 5G NR system, and may also be applied to a subsequent evolution system of the 5G NR system.

The present disclosure provides a solution for receiving a power saving signal through at least one frequency domain unit. The power saving signal may indicate whether a terminal is to wake up a main receiver or a main transceiver, so as to determine whether to process uplink data and/or downlink data by the main receiver or the main transceiver, which ensures that the terminal adjusts its own working state in accordance with the power saving signal, thereby improving the accuracy and reliability of terminal communications.

FIG. 2 illustrates a flowchart of a signal transmission method provided in an example of the present disclosure, which, for example, may be applied to the terminal and the access network device illustrated in FIG. 1. The method includes at least a part of the following contents.

At step 201, the access network device transmits a power saving signal to the terminal through at least one frequency domain unit.

At step 202, the terminal receives the power saving signal transmitted by the access network device through the at least one frequency domain unit, where the power saving signal indicates whether to wake up a main receiver or a main transceiver of the terminal, the main receiver is used to process downlink data, and the main transceiver is used to process uplink data and/or the downlink data.

One or more frequency domain units indicate one or more frequency domain locations. That is, one or more frequency domain units indicate one or more positions in the frequency domain where the power saving signal is transmitted. The power saving signal indicates whether to wake up the main receiver or the main transceiver of the terminal. That is, the access network device may wake up the main receiver or the main transceiver of the terminal through the power saving signal, or may not wake up the main receiver or the main transceiver of the terminal through the power saving signal. The main receiver is used to process the downlink data. The main transceiver is used to process the uplink data and/or the downlink data.

In some examples, the power saving signal is a wake up signal (WUS), a low power wake up signal (LP WUS), a paging early indication (PEI) signal, a download control information (DCI) for power saving (DCP) signal or another signal, which is not limited in the examples of the present disclosure.

In the example of the present disclosure, at least one frequency domain unit is configured between the access network device and the terminal. The access network device may transmit the power saving signal to the terminal through the at least one frequency domain unit, and thus the terminal may detect the at least one frequency domain unit and then receive the power saving signal transmitted by the access network device through the at least one frequency domain unit.

In some examples, the access network device transmits the power saving signal to the terminal through the at least one frequency domain unit. Upon receiving the power saving signal transmitted by the access network device through any one frequency domain unit, the terminal may determine that it is expected to wake up the main receiver or the main transceiver of the terminal. It may also be understood that it is an implicit indication mode that waking up the main receiver or the main transceiver of the terminal is directly triggered through the power saving signal in the example of the present disclosure.

In other examples, if the terminal is still to keep the main receiver or the main transceiver in the sleep state, the access network device does not transmit the power saving signal to the terminal through the at least one frequency domain unit. Therefore, it keeps the terminal from receiving the power saving signal, so that the terminal keeps the main receiver or the main transceiver in the sleep state.

In some examples, the power saving signal includes first indication information or second indication information. The first indication information instructs the terminal to wake up the main receiver or the main transceiver, and the second indication information instructs the terminal not to wake up the main receiver or the main transceiver. If the power saving signal transmitted by the access network device to the terminal includes the first indication information, the terminal wakes up the main receiver or the main transceiver in accordance with the first indication information included in the power saving signal. If the power saving signal transmitted by the access network device to the terminal includes the second indication information, the terminal keeps the main receiver or the main transceiver in the sleep state in accordance with the second indication information included in the power saving signal.

The present disclosure provides a solution for receiving the power saving signal through the at least one frequency domain unit. The power saving signal may indicate whether the terminal is to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

The example illustrated in FIG. 2 describes that the communications between the access network device and the terminal may be performed through the at least one frequency domain unit. The frequency domain unit may include different types, and the types of the frequency domain unit are described below.

In some examples, the frequency domain unit is a component carrier (CC), which is also called a carrier, or the frequency domain unit is a band width part (BWP).

Different types of frequency domain unit are described below.

As the first type, the frequency domain unit is the CC.

In the example of the present disclosure, the terminal may acquire the at least one frequency domain unit, and the at least one frequency domain unit of the terminal may be configured in different ways.

In some examples, the access network device configures at least one carrier for the terminal. Particularly, the access network device sends a first configuration signaling to the terminal, and the first configuration signaling is used to configure the at least one carrier. Upon receiving the first configuration signaling sent by the access network device, the terminal may determine the at least one carrier configured by the access network device.

In these examples of the present disclosure, the access network device may configure the at least one carrier for the terminal. After determining the at least one carrier, the access network device sends the first configuration signaling to the terminal, and the first configuration signaling may indicate the at least one carrier. The terminal may determine the at least one carrier configured by the access network device for the terminal based on the received first configuration signaling.

Alternatively, or additionally, the first configuration signaling is a dynamic signaling, a semi-static signaling or another signaling, which is not limited in the examples of the present disclosure.

For example, the first configuration signaling is a radio resource control (RRC) signaling, a media access control control element (MAC CE), or a DCI signaling.

In some alternative examples, the terminal may determine the at least one carrier in a default manner.

In these examples of the present disclosure, the at least one carrier of the terminal may be determined by the terminal in the default manner. That is, the terminal determines the at least one carrier by itself, instead of the access network device configuring the at least one carrier for the terminal.

In some examples, if the access network device does not configure the at least one carrier for the terminal through the first configuration signaling, which means that the terminal does not receive the first configuration signaling sent by the access network device, the terminal determines the at least one carrier in the default manner.

In some examples, the terminal determines the at least one carrier in the default manner, which includes the following.
(1) A carrier corresponding to a first cell is determined as the at least one carrier.

Particularly, the first cell is a primary cell (Pcell), a primary secondary cell (PScell) or another cell.

In the example of the present disclosure, the terminal may determine one or more carriers corresponding to the first cell as the at least one carrier. For example, one or more carriers corresponding to the primary cell are determined to be the at least one carrier. Alternatively, one or more carriers corresponding to the primary secondary cell are determined to be the at least one carrier.
(2) A carrier corresponding to a highest or lowest cell identity is determined as the at least one carrier.

In the example of the present disclosure, each cell has a cell identifier, and the terminal may determine one or more carriers corresponding to the cell with the highest cell identity among the cells as the at least one carrier. Alternatively, the terminal may determine one or more carriers corresponding to the cell with the lowest cell identity among the cells as the at least one carrier.
(3) A carrier corresponding to a largest or smallest subcarrier spacing of all configured BWPs as the at least one carrier.

In the example of the present disclosure, the terminal is configured with at least one BWP, and the terminal may determine one or more carriers corresponding to the largest subcarrier spacing of all the configured BWPs as the at least one carrier. Alternatively, the terminal may determine one or more carriers corresponding to the smallest subcarrier spacing of all the configured BWPs as the at least one carrier.

Particularly, each BWP corresponds to one subcarrier spacing. The terminal may select the largest subcarrier spacing or the smallest subcarrier spacing from the subcarrier spacings corresponding to all the configured BWPs, and then determine the one or more carriers corresponding to the selected subcarrier spacing as the at least one carrier.

These examples of the present disclosure provide a solution for determining the at least one carrier. The terminal may determine the at least one carrier, then receive the power saving signal transmitted by the access network device through the at least one carrier that is determined, and then determine whether to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

It is to be noted that in these examples of the present disclosure, it is described by taking how to determine the at least one carrier of the terminal as an example, while in another example, the terminal may be expected to determine a subcarrier spacing of the power saving signal. How to determine the subcarrier spacing of the power saving signal is described below.
(1) The subcarrier spacing of the power saving signal is the same as a subcarrier spacing of a first BWP configured in the at least one carrier.

In the example of the present disclosure, each carrier corresponds to one or more BWPs, and the terminal may determine that the subcarrier spacing of the power saving signal is the same as the subcarrier spacing of the first BWP configured in the at least one carrier.

In some examples, the access network device configures the first BWP for the terminal. Particularly, the access network device sends a second configuration signaling to the terminal, where the second configuration signaling is used to configure the first BWP, and the terminal receives the second configuration signaling sent by the access network device.

In these examples of the present disclosure, the access network device may determine the BWPs configured for the terminal, and select the first BWP from the configured BWPs, so as to configure the first BWP for the terminal through the second configuration signaling. Upon receiving the second configuration signaling sent by the access network device, the terminal may determine the first BWP.

In some examples, the second configuration signaling is a dynamic signaling, a semi-static signaling or another signaling, which is not limited in the examples of the present disclosure.

For example, the second configuration signaling is an RRC signaling, an MAC CE or a DCI signaling.

In some examples, the terminal may alternatively determine the first BWP in a default manner.

Alternatively, or additionally, in a case where the access network device does not configure the first BWP for the terminal, the terminal determines the first BWP in the default manner. That is, in a case where the terminal does not receive the second configuration signaling sent by the access network device, it determines that the first BWP is to be determined in the default manner.

Alternatively, or additionally, determining the first BWP in the default manner includes at least one of the following.
I. A BWP that is first activated is determined as the first BWP.

In the example of the present disclosure, at least one BWP configured for the terminal may be activated in order, and the terminal may determine the BWP that is first activated as the first BWP.

For example, the activated BWPs in the terminal are BWP1, BWP2, and BWP3 in order from first to last, and the terminal determines BWP1 as the first BWP.
II. A BWP that is most recently activated is determined as the first BWP.

In the example of the present disclosure, the at least one BWP configured for the terminal may be activated in order, and the terminal may determine the BWP that is most recently activated as the first BWP. It may also be understood that the BWP that is last activated is determined as the first BWP.

For example, the activated BWPs in the terminal are BWP1, BWP2, and BWP3 in order from first to last, and the terminal determines BWP3 as the first BWP.
III. A BWP with a lowest or highest center frequency within the carrier as the first BWP.

In the example of the present disclosure, each carrier includes at least one BWP, and each BWP corresponds to a center frequency, so that the terminal may determine the first BWP according to the values of the center frequencies of different BWPs.

In some examples, the BWP with the lowest center frequency within the carrier is determined as the first BWP. Alternatively, the BWP with the highest center frequency within the carrier is determined as the first BWP.
IV. An initial BWP of a first cell is determined as the first BWP.

In the example of the present disclosure, a cell has the initial BWP, and for the terminal, it may determine the initial BWP of the first cell as the first BWP.

In some examples, the first cell is a Pcell, a PScell or another cell, which is not limited in the examples of the present disclosure. For example, the initial BWP of the Pcell is determined as the first BWP, or the initial BWP of the PScell is determined as the first BWP.
(2) The subcarrier spacing of the power saving signal is the same as the largest subcarrier spacing of all the BWPs configured in a plurality of carriers.

In the example of the present disclosure, the terminal is configured with the plurality of carriers, each carrier corresponds to one or more BWPs, and each BWP corresponds to a subcarrier spacing. Therefore, the terminal may determine the largest subcarrier spacing of all the BWPs configured in the plurality of carriers as the subcarrier spacing of the power saving signal.
(3) The subcarrier spacing of the power saving signal is the same as the smallest subcarrier spacing of all the BWPs configured in a plurality of carriers.

In the example of the present disclosure, the terminal is configured with the plurality of carriers, each carrier corresponds to one or more BWPs, and each BWP corresponds to a subcarrier spacing. Therefore, the terminal may determine the smallest subcarrier spacing of all the BWPs configured in the plurality of carriers as the subcarrier spacing of the power saving signal.
(4) The subcarrier spacing of the power saving signal is the same as a subcarrier spacing of a corresponding BWP.

In the example of the present disclosure, the power saving signal is expected to be transmitted based on the BWP, so that the terminal may determine that the subcarrier spacing of the power saving signal is the subcarrier spacing of the BWP via which the power saving signal is transmitted.

These examples of the present disclosure provide a solution for determining the subcarrier spacing of the power saving signal. It is ensured that the terminal may determine the subcarrier spacing of the at least one carrier, then determine one or more frequency domain locations of the carrier, then receive the power saving signal transmitted by the access network device via the at least one carrier that is determined, and then determine whether to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

It is be noted that the power saving signal in the example of the present disclosure also corresponds to one or more frequency domain locations. How to determine the frequency domain location of the power saving signal is described below.

In some examples, the frequency domain location of the power saving signal includes at least one of the following situations.
(1) The frequency domain location of the power saving signal is the same as a frequency domain location where the access network device transmits a synchronization signal block (SSB) in the at least one carrier.

In the example of the present disclosure, the access network device may transmit the SSB through the at least one carrier, and the terminal may determine one or more frequency domain locations of the SSB transmitted by the access network device in at least one carrier as one or more frequency domain locations of the power saving signal.
(2) The frequency domain location of the power saving signal is the same as a frequency domain location of a search space set configured for the terminal in the at least one carrier.

In the example of the present disclosure, each of the at least one carrier configured for the terminal corresponds to a search space set, and the terminal may determine one or more frequency domain locations of one or more search space sets configured for the terminal in the at least one carrier as one or more frequency domain locations of the power saving signal.
(3) The frequency domain location of the power saving signal is an activated BWP in the at least one carrier.

In the example of the present disclosure, there are one or more activated BWPs in the at least one carrier configured for the terminal, and the terminal may determine the one or more activated BWP as one or more frequency domain locations of the power saving signal.
(4) A center frequency of the frequency domain location of the power saving signal is the same as a center frequency of a frequency domain location of an SSB in the at least one carrier.

In the example of the present disclosure, the at least one carrier may correspond to one or more SSBs, the frequency domain location of each SSB corresponds to a center frequency. The center frequency of the frequency domain location of the SSB in the at least one carrier is determined as the center frequency of the frequency domain location of the power saving signal, and thus one or more frequency domain locations of the power saving signal may be determined based on one or more determined center frequencies.
(5) A center frequency of the frequency domain location of the power saving signal is the same as a center frequency of a frequency domain location of a search space set in the at least one carrier.

In the example of the present disclosure, the at least one carrier corresponds to one or more search space sets, and the one or more search space sets corresponds to one or more frequency domain locations. The terminal may take one or more center frequencies of the one or more frequency domain locations of the one or more search space sets of the at least one carrier as one or more center frequencies of the frequency domain location of the power saving signal, and thus determine one or more frequency domain locations of the power saving signal based on the determined center frequencies.

It is to be noted that in the examples of the present disclosure, the at least one carrier includes at least one BWP, and the at least one BWP includes at least one activated BWP. Therefore, the terminal may receive the power saving signal transmitted by the access network device via the at least one activated BWP in at least one carrier.

It is to be noted that in these examples of the present disclosure, frequency domain protection intervals are left on both sides of the frequency domain location of the power saving signal to prevent interference between the power saving signals. In some examples, the frequency domain protection interval is defined by a communication protocol or is configured by the access network device, which is not limited in the examples of the present disclosure.

In the solutions provided in these examples of the present disclosure, the terminal may determine the one or more frequency domain locations of the power saving signal, that is, it may receive the power saving signal according to the determined frequency domain locations, and thus determine whether to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

As the second type, the frequency domain unit is a BWP.

In the example of the present disclosure, the terminal may acquire the at least one frequency domain unit, and the at least one frequency domain unit of the terminal may be configured in different ways.

In some examples, the access network device configures at least one BWP for the terminal. Particularly, the access network device sends a third configuration signaling to the terminal, and the third configuration signaling is used to configure the at least one BWP. Upon receiving the third configuration signaling sent by the access network device, the terminal may determine the at least one BWP configured by the access network device.

In these examples of the present disclosure, the access network device may configure the at least one BWP for the terminal. After determining the at least one BWP, the access network device sends the third configuration signaling to the terminal, and the third configuration signaling may indicate the at least one BWP. The terminal may determine the at least one BWP configured by the access network device for the terminal based on the received third configuration signaling.

Alternatively, or additionally, the third configuration signaling is a dynamic signaling, a semi-static signaling or another signaling, which is not limited in the examples of the present disclosure.

For example, the third configuration signaling is an RRC signaling, an MAC CE or a DCI signaling.

In some alternative examples, the terminal may determine the at least one BWP in a default manner.

In these examples of the present disclosure, the at least one BWP of the terminal may be determined by the terminal in the default manner. That is, the terminal determines the at least one BWP by itself, instead of the access network device configuring the at least one BWP for the terminal.

In some examples, if the access network device does not configure the at least one BWP for the terminal through the third configuration signaling, which means that the terminal does not receive the third configuration signaling sent by the access network device, the terminal determines the at least one BWP in the default manner.

In some examples, determining the at least one BWP in the default manner includes the following.
(1) A BWP that is first activated is determined as the at least one BWP.

In the example of the present disclosure, the at least one BWP configured for the terminal may be activated in order, and the terminal may determine the BWP that is first activated as the at least one BWP.

For example, the activated BWPs in the terminal are BWP1, BWP2, and BWP3 in order from first to last, and the terminal determines BWP1 as the at least one BWP.
(2) A BWP that is most recently activated is determined as the at least one BWP.

In the example of the present disclosure, the at least one BWP configured for the terminal may be activated in order, and the terminal may determine the BWP that is most recently activated as the at least one BWP. It may also be understood that the BWP that is last activated is determined as the at least one BWP.

For example, the activated BWPs in the terminal are BWP1, BWP2, and BWP3 in order from first to last, and the terminal determines BWP3 as the at least one BWP.
(3) An initial BWP of a primary cell is determined as the at least one BWP.

In the example of the present disclosure, the primary cell has the initial BWP, and for the terminal, it may determine the initial BWP of the primary cell as the at least one BWP.
(4) A first one of BWPs of one or more secondary cells is determined as the at least one BWP.

In the example of the present disclosure, the one or more secondary cells corresponds to a plurality of BWPs, and the terminal may determine the first one of the BWPs of the one or more secondary cells as the at least one BWP.
(5) A BWP with the largest or smallest subcarrier spacing is determined as the at least one BWP.

In an example of the present disclosure, the terminal is configured with a plurality of BWPs, and each BWP corresponds to a subcarrier spacing. The terminal may determine the BWP with the largest subcarrier spacing as the at least one BWP, or determine the BWP with the smallest subcarrier spacing as the at least one BWP.

It is to be noted that in these examples of the present disclosure, it is described by taking at least one of these five schemes to determine the at least one BWP as an example. In an alternative example, the terminal may determine the at least one BWP according to the BWPs supported by itself.

Alternatively, or additionally, the terminal determines the at least one BWP in the following way.
(1) All the BWPs supported by the terminal are determined as the at least one BWP.
(2) A part of the BWPs supported by the terminal are determined as the at least one BWP.

The part of BWPs supported by the terminal may be randomly selected from all the BWPs supported by the terminal.
(3) One or more activated BWPs among the BWPs supported by the terminal are determined as the at least one BWP.

The present disclosure provides a solution for the terminal to determine the at least one BWP, where the power saving signal transmitted by the access network device may be received through the at least one BWP. The power saving signal may indicate whether the terminal is to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

It is to be noted that in these examples of the present disclosure, it is described by taking how to determine the at least one BWP of the terminal as an example, while in another example, the terminal may be expected to determine a subcarrier spacing of the power saving signal. How to determine the subcarrier spacing of the power saving signal is described below.
(1) The subcarrier spacing of the power saving signal is the same as a subcarrier spacing of a second BWP in a case where the at least one BWP is at least one second BWP.

In the example of the present disclosure, the at least one BWP configured for the terminal includes the at least one second BWP, and thus the terminal may determine the subcarrier spacing of the at least one second BWP as the subcarrier spacing of the power saving signal.

In some examples, the access network device configures the second BWP for the terminal. Particularly, the access network device sends a fourth configuration signaling to the terminal, where the fourth configuration signaling is used to configure the second BWP, and the terminal receives the fourth configuration signaling sent by the access network device.

In these examples of the present disclosure, the access network device may determine the BWPs configured for the terminal, and select one or more second BWPs from the configured BWPs, so as to configure the one or more second BWPs for the terminal through the fourth configuration signaling. Upon receiving the fourth configuration signaling sent by the access network device, the terminal may determine the one or more second BWPs.

In some examples, the fourth configuration signaling is a dynamic signaling, a semi-static signaling or another signaling, which is not limited in the examples of the present disclosure.

For example, the fourth configuration signaling is an RRC signaling, an MAC CE or a DCI signaling.

In some examples, the terminal may alternatively determine the second BWP in a default manner.

Alternatively, or additionally, determining the second BWP in the default manner includes at least one of the following.
I. A BWP that is first activated is determined as the second BWP.
II. A BWP that is most recently activated is determined as the second BWP.
III. An initial BWP of a primary cell is determined as the second BWP.
IV. A first one of BWPs of one or more secondary cells is determined as the second BWP.
V. A BWP with a largest or smallest subcarrier spacing is determined as the second BWP.

Particularly, the manner in which the second BWP is determined in the examples of the present disclosure is similar to the described manner in which the at least one BWP is determined, and will not be repeated here. It may also be understood that the one or more second BWP in the examples of the present disclosure are the same as the at least one BWP determined in the foregoing examples.
(2) The subcarrier spacing of the power saving signal is the same as the largest subcarrier spacing of the at least one BWP, or the subcarrier spacing of the power saving signal is the same as the smallest subcarrier spacing of a plurality of BWPs.

In the example of the present disclosure, the terminal is configured with the plurality of BWP, each BWP corresponds to a subcarrier spacing, and the terminal may determine the largest subcarrier spacing of the plurality of BWPs as the subcarrier spacing of the power saving signal.

Alternatively, the terminal is configured with the plurality of BWPs, each BWP corresponds to a subcarrier spacing, and the terminal may determine the smallest subcarrier spacing of the plurality of BWPs as the subcarrier spacing of the power saving signal.
(3) The subcarrier spacing of the power saving signal is the same as a subcarrier spacing of a corresponding BWP.

In the example of the present disclosure, the power saving signal is expected to be transmitted based on the BWP, so that the terminal may determine that the subcarrier spacing of the power saving signal is the subcarrier spacing of the BWP via which the power saving signal is transmitted.

These examples of the present disclosure provide a solution for determining the subcarrier spacing of the power saving signal. It is ensured that the terminal may determine one or more frequency domain locations where the power saving signal is transmitted, then receive the power saving signal transmitted by the access network device, and then determine whether to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

It is be noted that the power saving signal in the example of the present disclosure also corresponds to one or more frequency domain locations. How to determine the frequency domain location of the power saving signal is described below.

In some examples, the frequency domain location of the power saving signal includes at least one of the following situations.
(1) The frequency domain location of the power saving signal is the same as a frequency domain location of the at least one BWP.
(2) The frequency domain location of the power saving signal is the same as a frequency domain location of a search space set configured for the terminal in the at least one BWP.

In the example of the present disclosure, each of the at least one BWP configured for the terminal corresponds to a search space set, and the terminal may determine one or more frequency domain locations of one or more search space sets configured for the terminal in the at least one BWP as one or more frequency domain locations of the power saving signal.
(3) A center frequency of the frequency domain location of the power saving signal is the same as a center frequency of a frequency domain location of a search space set of the at least one BWP.

In the example of the present disclosure, the at least one BWP corresponds to one or more search space sets, and the one or more search space sets correspond to one or more frequency domain locations. The terminal may take one or more center frequencies of the one or more frequency domain locations of the one or more search space sets of the at least one BWP as one or more center frequencies of one or more frequency domain locations of the power saving signal, and thus determine the one or more frequency domain locations of the power saving signal based on the determined center frequencies.
(4) A center frequency of the frequency domain location of the power saving signal is the same as a center frequency of the at least one BWP.

In the example of the present disclosure, each of the at least one BWP corresponds to a center frequency point, and one or more center frequencies of the at least one BWP are determined as one or more center frequencies of one or more frequency domain locations of the power saving signal, and then the one or more frequency domain locations of the power saving signal may be determined according to the determined center frequencies.

It is to be noted that in these examples of the present disclosure, frequency domain protection intervals are left on both sides of the frequency domain location of the power saving signal to prevent interference between the power saving signals. In some examples, the frequency domain protection interval is defined by a communication protocol or is configured by the access network device, which is not limited in the examples of the present disclosure.

In the solutions provided in these examples of the present disclosure, the terminal may determine the one or more frequency domain locations of the power saving signal, that is, it may receive the power saving signal according to the determined frequency domain locations, and thus determine whether to wake up the main receiver or the main transceiver, so as to determine whether to process the uplink data and/or the downlink data by the main receiver or the main transceiver, which ensures that the terminal adjusts its own working state in accordance with the power saving signal, thereby improving the accuracy and reliability of terminal communications.

It is to be noted that the described examples may be divided into new examples, or combined with other examples to form new examples. This present disclosure does not limit the combinations of the examples.

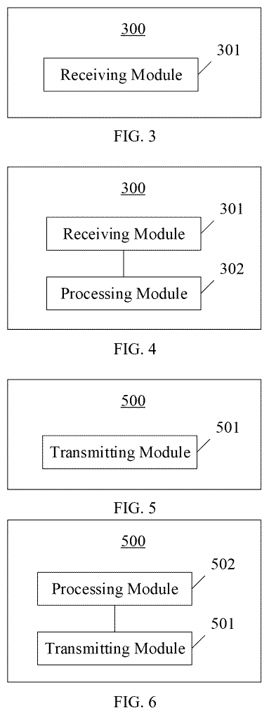

FIG. 3 illustrates a block diagram of a signal receiving apparatus 300 provided in an example of the present disclosure. Referring to FIG. 3, the apparatus 300 includes a receiving module 301.

The receiving module 301 is configured to receive a power saving signal transmitted by an access network device through at least one frequency domain unit. The power saving signal indicates whether to wake up a main receiver or a main transceiver of a terminal, the main receiver is used to process downlink data, and the main transceiver is used to process uplink data and/or the downlink data.

In some examples, the frequency domain unit is a CC.

In some examples, referring to FIG. 4, the apparatus further includes the receiving module 301 or a processing module 302.

The receiving module 301 is configured to receive a first configuration signaling sent by the access network device, where the first configuration signaling is used to configure the at least one carrier.

The processing module 302 is configured to determine the at least one carrier in a default manner.

In some examples, the processing module 302 that is configured to: determine a carrier corresponding to a first cell as the at least one carrier, or determine a carrier corresponding to a highest or lowest cell identity as the at least one carrier, or determine a carrier corresponding to the largest or smallest subcarrier spacing of all configured BWPs as the at least one carrier.

In some examples, a subcarrier spacing of the power saving signal is the same as a subcarrier spacing of a first BWP configured in the at least one carrier.

In some examples, the receiving module 301 that is used to receive a second configuration signaling sent by the access network device, where the second configuration signaling is used to configure the first BWP; or the processing module 302 that is used to determine the first BWP in a default manner.

In some examples, determining the first BWP in the default manner includes at least one of the following: determining a BWP that is first activated as the first BWP; determining a BWP that is most recently activated as the first BWP; determining a BWP with the lowest or highest center frequency within the carrier as the first BWP; or determining an initial BWP of the first cell as the first BWP.

In some examples, the subcarrier spacing of the power saving signal is the same as the largest subcarrier spacing of all the BWPs configured in a plurality of carriers, or the subcarrier spacing of the power saving signal is the same as the smallest subcarrier spacing of all the BWPs configured in the plurality of carriers.

In some examples, the subcarrier spacing of the power saving signal is the same as the subcarrier spacing of a corresponding BWP.

In some examples, the frequency domain location of the power saving signal is the same as a frequency domain location where the access network device transmits an SSB in the at least one carrier; or the frequency domain location of the power saving signal is the same as a frequency domain location of a search space set configured for the terminal in the at least one carrier; or the frequency domain location of the power saving signal is an activated BWP in the at least one carrier; or a center frequency of the frequency domain location of the power saving signal is the same as a center frequency of a frequency domain location of an SSB in the at least one carrier, or a center frequency of the frequency domain location of the power saving signal is the same as a center frequency of a frequency domain location of a search space set in the at least one carrier.

In some examples, the receiving module 301 is configured to receive a power saving signal transmitted by the access network device through at least one activated BWP in the at least one carrier.

In some examples, the frequency domain unit is a BWP.

In some examples, the receiving module 301 that is configured to receive a third configuration signaling sent by the access network device, where the third configuration signaling is used to configure at least one BWP; or the processing module 302 that is configured to determine the at least one BWP in a default manner.

In some examples, the subcarrier spacing of the power saving signal is the same as a subcarrier spacing of a second BWP in case where the at least one BWP is at least one second BWP.

In some examples, the receiving module 301 that is used to receive a fourth configuration signaling sent by the access network device, where the fourth configuration signaling is used to configure the second BWP; or the processing module 302 that is used to determine the second BWP in a default manner.

In some examples, determining the second BWP in the default manner includes at least one of the following: determining a BWP that is first activated as the second BWP; determining a BWP that is most recently activated is determined as the second BWP; determining an initial BWP of a primary cell as the second BWP; determining a first one of BWPs of one or more secondary cells as the second BWP; or determining a BWP with the largest or smallest subcarrier spacing as the second BWP.

In some examples, the subcarrier spacing of the power saving signal is the same as the largest subcarrier spacing of the at least one BWP, or the subcarrier spacing of the power saving signal is the same as the smallest subcarrier spacing of a plurality of BWPs.

In some examples, the subcarrier spacing of the power saving signal is the same as the subcarrier spacing of a corresponding BWP.

In some examples, a frequency domain location of the power saving signal is the same as a frequency domain location of the at least one BWP; or the frequency domain location of the power saving signal is the same as a frequency domain location of a search space set configured for the terminal in the at least one BWP; or a center frequency of the frequency domain location of the power saving signal is the same as a center frequency of a frequency domain location of a search space set of the at least one BWP, or a center frequency of the frequency domain location of the power saving signal is the same as a center frequency of the at least one BWP.

It is to be noted that the division of the above functional modules is only used as an example for illustrating how to realize the functions of each apparatus provided in the above examples. In actual applications, the above functions may be assigned to different functional modules for implementation according to actual needs. That is, the internal structure of the apparatus may be divided into different functional modules to complete all or a part of the functions described above. In addition, the apparatuses provided by the above examples belong to the same concept as the method examples, and their specific implementation processes are detailed in the method examples and are not repeated here.

FIG. 5 illustrates a block diagram of a signal receiving apparatus 500 provided in an example of the present disclosure. Referring to FIG. 5, the apparatus 500 includes a transmitting module 501.

The transmitting module 501 is configured to transmit a power saving signal to a terminal through at least one frequency domain unit. The power saving signal indicates whether to wake up a main receiver or a main transceiver of the terminal, the main receiver is used to process downlink data, and the main transceiver is used to process uplink data and/or the downlink data.

In some examples, the frequency domain unit is a CC.

In some examples, referring to FIG. 6, the apparatus 500 further includes the sending module 501 or a processing module 502.

The sending module 501 is configured to send a first configuration signaling to a terminal, where the first configuration signaling is used to configure at least one carrier. The processing module 502 is configured to determine the at least one carrier in a default manner.

In some examples, the processing module 502 that is configured to determine a carrier corresponding to a first cell as the at least one carrier, or determine a carrier corresponding to the highest or lowest cell identity as the at least one carrier, or determine a carrier corresponding to the largest or smallest subcarrier spacing of all configured BWPs as the at least one carrier.

In some examples, a subcarrier spacing of the power saving signal is the same as a subcarrier spacing of a first BWP configured in the one or more carriers.

In some examples, the sending module 501 that is configured to send a second configuration signaling to the terminal, where the second configuration signaling is used to configure the first BWP; or the processing module 502 that is configured to determine the first BWP in a default manner.

In some examples, the default manner includes at least one of the following: determining a BWP that is first activated as the first BWP; determining a BWP that is most recently activated as the first BWP; determining a BWP with the lowest or highest center frequency within the carrier as the first BWP; or determining an initial BWP of the first cell as the first BWP.

In some examples, the subcarrier spacing of the power saving signal is the same as the largest subcarrier spacing of all the BWPs configured in the plurality of carriers, or the subcarrier spacing of the power saving signal is the same as the smallest subcarrier spacing of all the BWPs configured in the plurality of carriers.

In some examples, the subcarrier spacing of the power saving signal is the same as the subcarrier spacing of a corresponding BWP.

In some examples, a frequency domain location of the power saving signal is the same as a frequency domain location where the access network device transmits an SSB in the at least one carrier, or where the frequency domain location of the power saving signal is the same as a frequency domain location of a search space set configured for the terminal in the at least one carrier, or where a frequency domain location of the power saving signal is an activated BWP in the at least one carrier, or where a center frequency of a frequency domain location of the power saving signal is the same as a center frequency of a frequency domain location of an SSB in the at least one carrier, or where a center frequency of a frequency domain location of the power saving signal is the same as a center frequency of a frequency domain location of a search space set in the at least one carrier.

In some examples, the transmitting module 501 is further configured to transmit the power saving signal to the terminal via at least one activated BWP in the at least one carrier.

In some examples, the frequency domain unit is a BWP.

In some examples, referring to FIG. 6, the apparatus further includes: the transmitting module 501 that is configured to sending a third configuration signaling to the terminal, where the third configuration signaling is used to configure the at least one BWP; or the processing module 502 that is configured to determine the at least one BWP in a default manner.

In some examples, the subcarrier spacing of the power saving signal is the same as a subcarrier spacing of a second BWP in case where the at least one BWP is at least one second BWP.

In some examples, referring to FIG. 6, the apparatus further includes: the transmitting module 501 that is configured to send a fourth configuration signaling to the terminal, where the fourth configuration signaling is used to configure the second BWP; or the processing module 502 that is configured to determine the second BWP in a default manner.

In some examples, the default manner includes at least one of the following: determining a BWP that is first activated as the second BWP; determining a BWP that is most recently activated is determined as the second BWP; determining an initial BWP of a primary cell as the second BWP; determining a first one of BWPs of one or more secondary cells as the second BWP; or determining a BWP with the largest or smallest subcarrier spacing as the second BWP.

In some examples, the subcarrier spacing of the power saving signal is the same as the largest subcarrier spacing of the at least one BWP, or the subcarrier spacing of the power saving signal is the same as the smallest subcarrier spacing of a plurality of BWPs.

In some examples, the subcarrier spacing of the power saving signal is the same as the subcarrier spacing of a corresponding BWP.

In some embodiments, the frequency domain location of the power saving signal is the same as the frequency domain location of at least one BWP, or the frequency domain location of the power saving signal is the same as the frequency domain location of a search space set configured for the terminal in at least one BWP, or the center frequency of the frequency domain location of the power saving signal is the same as the center frequency of the frequency domain location of the search space set of at least one BWP, or the center frequency of the frequency domain location of the power saving signal is the same as the center frequency point of at least one BWP.

It is to be noted that the division of the above functional modules is only used as an example for illustrating how to realize the functions of each apparatus provided in the above examples. In actual applications, the above functions may be assigned to different functional modules for implementation according to actual needs. That is, the internal structure of the apparatus may be divided into different functional modules to complete all or a part of the functions described above. In addition, the apparatuses provided by the above examples belong to the same concept as the method examples, and their specific implementation processes are detailed in the method examples and are not repeated here.

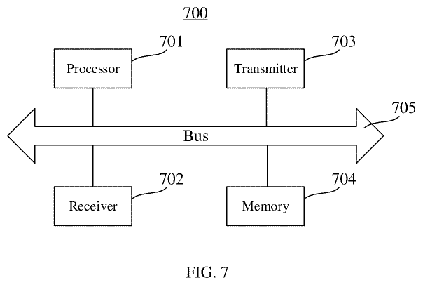

FIG. 7 illustrates a schematic structural diagram of a communication device 700 provided in an example of the present disclosure. The communication device 700 includes: a processor 701, a receiver 702, a transmitter 703, a memory 704 and a bus 705.

The processor 701 includes one or more processing cores. The processor 701 performs various functional applications and information processing by running software programs and modules.

The receiver 702 and the transmitter 703 may be implemented as a communication component, which may be a communication chip.

The memory 704 is connected to the processor 701 through the bus 705.

The memory 704 may be configure to store at least one piece of program code, and the processor 701 is configured to execute the at least one piece of program code to implement each step in the method examples.

In addition, the communication device may be a terminal or an access network device. The memory 704 may be implemented by any type of volatile or nonvolatile storage device or a combination thereof, including but not limited to: a magnetic disk or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In an example, a computer-readable storage medium is also provided, in which executable program codes are stored. The executable program codes are loaded and executed by one or more processors to implement the signal transmitting methods or the signal receiving methods performed by the communication device provided in the various method examples.

In an example, a chip is provided. The chip includes a programmable logic circuit and/or program instructions. When running on a terminal or an access network device, the chip is configured to implement the signal transmitting methods and the signal receiving methods provided in the method examples.

In an example, a communication system is provided, which includes a terminal and an access network device. The terminal is configured to implement the signal receiving methods as described above, and the access network device is configured to implement the signal transmitting methods as described above.

In an example, a computer program product is provided. When executed by one or more processors of a terminal or an access network device, the computer program product is configured to implement the signal transmitting methods or the signal receiving methods provided in the various method examples.

Persons of ordinary skill in the art may understand that the implementation of all or part of the steps in the above examples may be accomplished by hardware or by instructing related hardware through a program. The program may be stored in a computer-readable storage medium. The above-mentioned storage medium may be a read-only memory, a disk or an optical disk, etc.

The above are only some alternative or additional examples of the present disclosure, and are not intended to limit the present disclosure. Any modifications, equivalent replacements, improvements, etc. made within the spirit and principles of the present disclosure shall be included in the protection scope of the present disclosure.

1. A signal receiving method, performed by a terminal, comprising:
receiving a power saving signal transmitted by an access network device through at least one frequency domain unit, wherein the power saving signal indicates whether to wake up a main receiver or a main transceiver of the terminal, the main receiver is used to process downlink data, and the main transceiver is used to process at least one of uplink data or the downlink data.

2. The method according to claim 1, wherein the at least one frequency domain unit is at least one carrier or at least one bandwidth part (BWP).

3. The method according to claim 2, wherein the at least one frequency domain unit is the at least one carrier, the method further comprising:
receiving a first configuration signaling sent by the access network device, wherein the first configuration signaling is used to configure the at least one carrier; or
determining the at least one carrier in a default manner, wherein the determining comprises one of:
determining a carrier corresponding to a first cell as the at least one carrier;
determining a carrier corresponding to a highest or lowest cell identity as the at least one carrier; or
determining a carrier corresponding to a largest or smallest subcarrier spacing of all configured BWPs as the at least one carrier.

4. (canceled)

5. The method according to claim 2, wherein the at least one frequency domain unit is the at least one carrier, and wherein at least one of a subcarrier spacing of the power saving signal or a frequency domain location of the power saving signal is determined;
for the subcarrier spacing of the power saving signal:
the subcarrier spacing of the power saving signal is identical to a subcarrier spacing of a first BWP configured in the at least one carrier; or
the subcarrier spacing of the power saving signal is identical to a largest subcarrier spacing of all BWPs configured in the at least one carrier, or the subcarrier spacing of the power saving signal is identical to a smallest subcarrier spacing of all the BWPs configured in the at least one carrier; or
the subcarrier spacing of the power saving signal is identical to a subcarrier spacing of a corresponding BWP;
for the frequency domain location of the power saving signal:
the frequency domain location of the power saving signal is identical to a frequency domain location where the access network device transmits a synchronization signal block (SSB) in the at least one carrier, or
the frequency domain location of the power saving signal is identical to a frequency domain location of a search space set configured for the terminal in the at least one carrier, or
the frequency domain location of the power saving signal is an activated BWP in the at least one carrier, or
a center frequency of the frequency domain location of the power saving signal is identical to a center frequency of the frequency domain location of the SSB in the at least one carrier, or
the center frequency of the frequency domain location of the power saving signal is identical to a center frequency of the frequency domain location of the search space set in the at least one carrier.

6. The method according to claim 5, further comprising:
receiving a second configuration signaling sent by the access network device, wherein the second configuration signaling is used to configure the first BWP; or
determining the first BWP in a default manner, wherein the determining comprises at least one of:
determining a BWP that is first activated as the first BWP;
determining a BWP that is most recently activated as the first BWP;
determining a BWP with a lowest or highest center frequency in the at least one carrier as the first BWP; or
determining an initial BWP of a first cell as the first BWP.

7.-10. (canceled)

11. The method according to claim 2, wherein the at least one frequency domain unit is the at least one carrier, and receiving the power saving signal transmitted by the access network device through the at least one frequency domain unit comprises:
receiving the power saving signal transmitted by the access network device through at least one activated BWP in the at least one carrier.

12. (canceled)

13. The method according to claim 2, wherein the at least one frequency domain unit is the at least one BWP, the method further comprising:
receiving a third configuration signaling sent by the access network device, wherein the third configuration signaling is used to configure the at least one BWP; or
determining the at least one BWP in a default manner.

14. The method according to claim wherein the at least one frequency domain unit is the at least one BWP, and wherein at least one of a subcarrier spacing of the power saving signal or a frequency domain location of the power saving signal is determined;
for the subcarrier spacing of the power saving signal,
the subcarrier spacing of the power saving signal is identical to a subcarrier spacing of a second BWP among the at least one BWP; or
the subcarrier spacing of the power saving signal is identical to a largest subcarrier spacing of the at least one BWP, or the subcarrier spacing of the power saving signal is identical to a smallest subcarrier spacing of the at least one BWP; or
the subcarrier spacing of the power saving signal is identical to a subcarrier spacing of a corresponding BWP;
for the frequency domain location of the power saving signal:
the frequency domain location of the power saving signal is identical to a frequency domain location of the at least one BWP, or
the frequency domain location of the power saving signal is identical to a frequency domain location of a search space set configured for the terminal in the at least one BWP, or
a center frequency of the frequency domain location of the power saving signal is identical to a center frequency of the frequency domain location of the search space set of the at least one BWP, or
the center frequency of the frequency domain location of the power saving signal is identical to a center frequency of the at least one BWP.

15. The method according to claim 14, further comprising:
receiving a fourth configuration signaling sent by the access network device, wherein the fourth configuration signaling is used to configure the second BWP; or
determining the second BWP in a default manner, wherein the determining comprises at least one of:
determining a BWP that is first activated as the second BWP;
determining a BWP that is most recently activated as the second BWP;
determining an initial BWP of a primary cell as the second BWP;
determining a first one of BWPs of one or more secondary cells as the second BWP; or
determining a BWP with a largest or smallest subcarrier spacing as the second BWP.

16.-19. (canceled)

20. A signal transmitting method, performed by an access network device, comprising:
transmitting a power saving signal to a terminal through at least one frequency domain unit, wherein the power saving signal indicates whether to wake up a main receiver or a main transceiver of the terminal, the main receiver is used to process downlink data, and the main transceiver is used to process at least one of uplink data or the downlink data.

21. The method according to claim 20, wherein the at least one frequency domain unit is at least one carrier or at least one bandwidth part (BWP).

22. The method according to claim 21, wherein the at least one frequency domain unit is the at least one carrier, the method further comprising:
transmitting a first configuration signaling to the terminal, wherein the first configuration signaling is used to configure the at least one carrier; or
determining the at least one carrier in a default manner;
wherein the method further comprises one of:
determining a carrier corresponding to a first cell as the at least one carrier;
determining a carrier corresponding to a highest or lowest cell identity as the at least one carrier, or
determining a carrier corresponding to a largest or smallest subcarrier spacing of all configured BWPs as the at least one carrier.

23. (canceled)

24. The method according to claim 21, wherein the at least one frequency domain unit is the at least one carrier, and wherein at least one of a subcarrier spacing of the power saving signal or a frequency domain location of the power saving signal is determined;
for the subcarrier spacing of the power saving signal:
the subcarrier spacing of the power saving signal is identical to a subcarrier spacing of a first BWP configured in the at least one carrier; or
the subcarrier spacing of the power saving signal is identical to a largest subcarrier spacing of all BWPs configured in the at least one carrier, or the subcarrier spacing of the power saving signal is identical to a smallest subcarrier spacing of all the BWPs configured in the at least one carrier; or
the subcarrier spacing of the power saving signal is identical to a subcarrier spacing of a corresponding BWP;
for the frequency domain location of the power saving signal:
the frequency domain location of the power saving signal is identical to a frequency domain location where the access network device transmits a synchronization signal block (SSB) in the at least one carrier, or
the frequency domain location of the power saving signal is identical to a frequency domain location of a search space set configured for the terminal in the at least one carrier, or
the frequency domain location of the power saving signal is an activated BWP in the at least one carrier, or
a center frequency of the frequency domain location of the power saving signal is identical to a center frequency of the frequency domain location of the SSB in the at least one carrier, or
the center frequency of the frequency domain location of the power saving signal is identical to a center frequency of the frequency domain location of the search space set in the at least one carrier.

25. The method according to claim 24, further comprising:
sending a second configuration signaling to the terminal, wherein the second configuration signaling is used to configure the first BWP; or
determining the first BWP in a default manner, wherein the determining comprises at least one of:
determining a BWP that is first activated as the first BWP;
determining a BWP that is most recently activated as the first BWP;
determining a BWP with a lowest or highest center frequency in the carrier as the first BWP; or
determining an initial BWP of a first cell as the first BWP.

26.-29. (canceled)

30. The method according to claim 21, wherein the at least one frequency domain unit is the at least one carrier, and wherein transmitting the power saving signal to the terminal through the at least one frequency domain unit comprises:
transmitting the power saving signal to the terminal through at least one activated BWP in the at least one carrier.

31. (canceled)

32. The method according to claim 21, wherein the at least one frequency domain unit is the at least one BWP, the method further comprising:
sending a third configuration signaling to the terminal, wherein the third configuration signaling is used to configure the at least one BWP; or
determining the at least one BWP in a default manner.

33. The method according to claim 21, wherein the at least one frequency domain unit is the at least one BWP, and wherein at least one of a subcarrier spacing of the power saving signal or a frequency domain location of the power saving signal is determined;
for the subcarrier spacing of the power saving signal:
the subcarrier spacing of the power saving signal is identical to a subcarrier spacing of a second BWP; or
the subcarrier spacing of the power saving signal is identical to a largest subcarrier spacing of the at least one BWP, or the subcarrier spacing of the power saving signal is identical to a smallest subcarrier spacing of the at least one BWP; or
the subcarrier spacing of the power saving signal is identical to a subcarrier spacing of a corresponding BWP;
for the frequency domain location of the power saving signal:
the frequency domain location of the power saving signal is identical to a frequency domain location of the at least one BWP, or
the frequency domain location of the power saving signal is identical to a frequency domain location of a search space set configured for the terminal in the at least one BWP, or
a center frequency of the frequency domain location of the power saving signal is identical to a center frequency of the frequency domain location of the search space set of the at least one BWP, or
the center frequency of the frequency domain location of the power saving signal is identical to a center frequency of the at least one BWP.

34. The method according to claim 33, further comprising:
sending a fourth configuration signaling to the terminal, wherein the fourth configuration signaling is used to configure the second BWP; or
determining the second BWP in a default manner, wherein the determining comprises at least one of:
determining a BWP that is first activated as the second BWP;
determining a BWP that is most recently activated as the second BWP;
determining an initial BWP of a primary cell as the second BWP;
determining a first one of BWPs of one or more secondary cells as the second BWP; or
determining a BWP with a largest or smallest subcarrier spacing as the second BWP.

35.-40. (canceled)

41. A terminal, comprising:
one or more processors; and
one or more transceivers connected to the one or more processors;
wherein the one or more processors are configured to:
receive a power saving signal transmitted by an access network device through at least one frequency domain unit, wherein the power saving signal indicates whether to wake up a main receiver or a main transceiver of the terminal, the main receiver is used to process downlink data, and the main transceiver is used to process at least one of uplink data or the downlink data.

42. An access network device, comprising:
one or more processors; and
one or more transceivers connected to the one or more processors;
wherein the one or more processors are configured to perform the signal transmitting method according to claim 20.

43. (canceled)

44. (canceled)
